(19) United States
(12) Patent Application Publication
(10) Pub. No.: US 2023/0092228 A1
(43) Pub. Date: Mar. 23, 2023

(54) CLOAKING PATTERN IN ELECTROCHROMIC DEVICES

(71) Applicant: SAGE ELECTROCHROMICS, INC., Faribault, MN (US)

(72) Inventors: Cody Daniel VanDerVeen, Faribault, MN (US); Jean-Christophe GIRON, Edina, MN (US)

(21) Appl. No.: 17/932,652

(22) Filed: Sep. 15, 2022

Related U.S. Application Data
(60) Provisional application No. 63/247,452, filed on Sep. 23, 2021.

(51) Int. Cl. G02F 1/153; G02F 1/1514

(52) U.S. Cl. CPC G02F 1/1533; G02F 1/1514; G02F 2001/1536; G02F 2001/15145

(57) ABSTRACT

An electrochromic device and method of cloaking an electrochromic device is disclosed. The electrochromic device can include a first transparent conductive layer on a substrate, a second transparent conductive layer, a cathodic electrochromic layer between the first transparent conductive layer and the second transparent conductive layer, and an anodic electrochromic layer between the first transparent conductive layer and the second transparent conductive layer. The stack of layers can be patterned to be parallel to a voltage gradient of the electrochromic device and extend through all layers of the electrochromic device. The electrochromic device can also include a masking layer that covers the patterned inactive area. A method can include determining a pattern of inactive areas within a visible area, determining a cloaking pattern that corresponds to the pattern of inactive areas, and depositing a masking layer in the areas of the cloaking pattern.

### CROSS-REFERENCE TO RELATED APPLICATION(S)

This application claims priority under 35 U.S.C. § 119(e) to U.S. Provisional Application No. 63/247,452, entitled “CLOAKING PATTERN IN ELECTROCHROMIC DEVICES,” by Cody VanDerVeen et al., filed Sep. 23, 2021, which is assigned to the current assignee hereof and incorporated herein by reference in its entirety.

### FIELD OF THE DISCLOSUE

The present disclosure is related to electrochemical devices and method of forming the same.

### BACKGROUND

An electrochemical device can include an electrochromic stack where transparent conductive layers are used to provide electrical connections for the operation of the stack. Electrochromic (EC) devices employ materials capable of reversibly altering their optical properties following electrochemical oxidation and reduction in response to an applied potential. Electrochromic devices alter the color, transmittance, absorbance, and reflectance of energy by inducing a change the electrochemical material. Specifically, the optical modulation is the result of the simultaneous insertion and extraction of electrons and charge compensating ions in the electrochemical material lattice. Advances in electrochromic devices seek to have devices with telecommunication enabled features that do not interfere with switching speeds of the electrochromic device.

As such, further improvements are sought in manufacturing electrochromic devices.

### BRIEF DESCRIPTION OF THE DRAWINGS

FIG. 1 is a schematic cross-section of an electrochromic device, according to one embodiment.

FIG. 2 is a method of cloaking an electrochromic device, according to one embodiment.

FIGS. 3A-3D are schematic top views of one or more electrochromic with a patterned laminate layer, as described above.

FIG. 4 is a schematic illustration of a masking layer in a cloaking pattern, according to one embodiment.

FIG. 5 is a schematic illustration of an insulated glazing unit, according to the embodiment of the current disclosure.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific embodiments and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The use of the word “about,” “approximately,” or “substantially” is intended to mean that a value of a parameter is close to a stated value or position. However, minor differences may prevent the values or positions from being exactly as stated.

Patterned features, which include bus bars, holes, holes, etc., can have a width, a depth or a thickness, and a length, where the length is greater than the width and the depth or thickness. As used in this specification, a diameter is a width for a circle, and a minor axis is a width for an ellipse.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the glass, vapor deposition, and electrochromic arts.

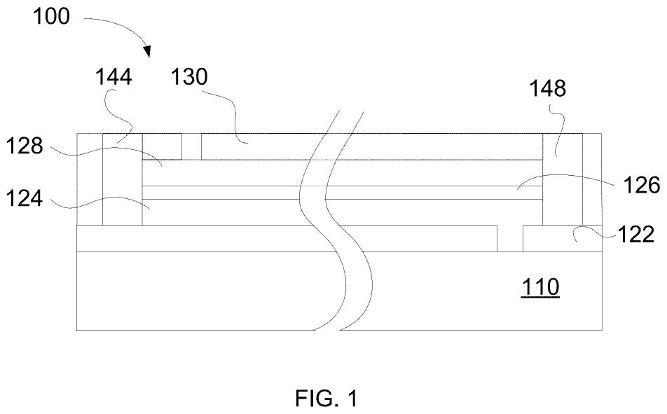

In accordance with the present disclosure, FIG. 1 illustrates a cross-section view of a partially fabricated electrochemical device 100 having an improved film structure. For purposes of illustrative clarity, the electrochemical device 100 is a variable transmission device. In one embodiment, the electrochemical device 100 can be an electrochromic device. In another embodiment, the electrochemical device 100 can be a thin-film battery. In another embodiment, the electrochemical device 100 can be used within an insulated glazing unit, window, or other laminate structure. However, it will be recognized that the present disclosure is similarly applicable to other types of scribed electroactive devices, electrochemical devices, as well as other electrochromic devices with different stacks or film structures (e.g., additional layers). With regard to the electrochemical device 100 of FIG. 1, the device 100 may include a substrate 110 and a stack overlying the substrate 110. The stack may include a first transparent conductor layer 122, a cathodic electrochemical layer 124, an anodic electrochemical layer 128, and a second transparent conductor layer 130. In one embodiment, the stack may also include an ion conducting layer 126 between the cathodic electrochemical layer 124 and the anodic electrochemical layer 128, and a UV reflective laminate layer 150 over the entire stack.

In an embodiment, the substrate 110 can include a glass substrate, a sapphire substrate, an aluminum oxynitride substrate, or a spinel substrate. In another embodiment, the substrate 110 can include a transparent polymer, such as a polyacrylic compound, a polyalkene, a polycarbonate, a polyester, a polyether, a polyethylene, a polyimide, a polysulfone, a polysulfide, a polyurethane, a polyvinylacetate, another suitable transparent polymer, or a co-polymer of the foregoing. The substrate 110 may or may not be flexible. In a particular embodiment, the substrate 110 can be float glass or a borosilicate glass and have a thickness in a range of 0.5 mm to 12 mm thick. The substrate 110 may have a thickness no greater than 16 mm, such as 12 mm, no greater than 10 mm, no greater than 8 mm, no greater than 6 mm, no greater than 5 mm, no greater than 3 mm, no greater than 2 mm, no greater than 1.5 mm, no greater than 1 mm, or no greater than 0.01 mm. In another particular embodiment, the substrate 110 can include ultra-thin glass that is a mineral glass having a thickness in a range of 50 microns to 300 microns. In a particular embodiment, the substrate 110 may be used for many different electrochemical devices being formed and may referred to as a motherboard.

Transparent conductive layers 122 and 130 can include a conductive metal oxide or a conductive polymer. Examples can include a tin oxide or a zinc oxide, either of which can be doped with a trivalent element, such as Al, Ga, In, or the like, a fluorinated tin oxide, or a sulfonated polymer, such as polyaniline, polypyrrole, poly(3,4-ethylenedioxythiophene), or the like. In another embodiment, the transparent conductive layers 122 and 130 can include gold, silver, copper, nickel, aluminum, or any combination thereof. The transparent conductive layers 122 and 130 can include indium oxide, indium tin oxide, doped indium oxide, tin oxide, doped tin oxide, zinc oxide, doped zinc oxide, ruthenium oxide, doped ruthenium oxide and any combination thereof. The transparent conductive layers 122 and 130 can have a thickness between 10 nm and 600 nm. In one embodiment, the transparent conductive layers 122 and 130 can have a thickness between 200 nm and 500 nm. In one embodiment, the transparent conductive layers 122 and 130 can have a thickness between 320 nm and 460 nm. In one embodiment the first transparent conductive layer 122 can have a thickness between 10 nm and 600 nm. In one embodiment, the second transparent conductive layer 130 can have a thickness between 80 nm and 600 nm.

The layers 124 and 128 can be electrode layers, where one of the layers may be a cathodic electrochemical layer, and the other of the layers may be an anodic electrochromic layer (also referred to as a counter electrode layer). In one embodiment, the cathodic electrochemical layer 124 is an electrochromic layer. The cathodic electrochemical layer 124 can include an inorganic metal oxide material, such as WO₃, V₂O₅, MoO₃, Nb₂O₅, TiO₂, CuO, Ni₂O₃, NiO, Ir₂O₃, Cr₂O₃, Co₂O₃, Mn₂O₃, mixed oxides (e.g., W—Mo oxide, W—V oxide), or any combination thereof and can have a thickness in a range of 40 nm to 600 nm. In one embodiment, the cathodic electrochemical layer 124 can have a thickness between 100 nm to 400 nm. In one embodiment, the cathodic electrochemical layer 124 can have a thickness between 350 nm to 390 nm. The cathodic electrochemical layer 124 can include lithium, aluminum, zirconium, phosphorus, nitrogen, fluorine, chlorine, bromine, iodine, astatine, boron; a borate with or without lithium; a tantalum oxide with or without lithium; a lanthanide-based material with or without lithium; another lithium-based ceramic material; or any combination thereof.

The anodic electrochromic layer 128 can include any of the materials listed with respect to the cathodic electrochromic layer 124 or Ta₂O₅, ZrO₂, HfO₂, Sb₂O₃, or any combination thereof, and may further include nickel oxide (NiO, Ni₂O₃, or combination of the two), and Li, Na, H, or another ion and have a thickness in a range of 40 nm to 500 nm. In one embodiment, the anodic electrochromic layer 128 can have a thickness between 150 nm to 300 nm. In one embodiment, the anodic electrochromic layer 128 can have a thickness between 250 nm to 290 nm. In some embodiments, lithium may be inserted into at least one of the first electrode 130 or second electrode 140.

In another embodiment, the device 100 may include a plurality of layers between the substrate 110 and the first transparent conductive layer 122. In one embodiment, an antireflection layer can be between the substrate 110 and the first transparent conductive layer 122. The antireflection layer can include SiO₂, NbO₂, Nb₂O₅ and can be a thickness between 20 nm to 100 nm. The device 100 may include at least two bus bars with one bus bar 144 electrically connected to the first transparent conductive layer 122 and the second bus bar 148 electrically connected to the second transparent conductive layer 130.

The electrochromic device 100 can have areas of inactivity, whether by contamination or purposeful scribing to cause inactivity. Such areas of inactivity will not tint or go from a clear state to a tinted state. As such, the areas of inactivity become apparent when the electrochromic device is in the tinted state. In order to make the contrast less apparent, a cloaking pattern can be employed, as described below.

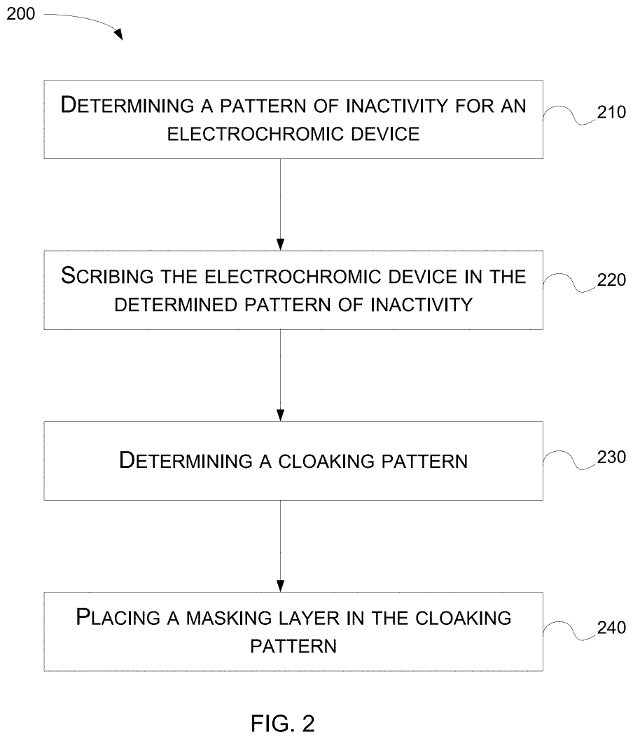

FIG. 2 is a method of cloaking an electrochromic device, such as device 100 described above. The method can begin, at step 210, by determining a pattern of inactivity for the electrochromic device. In one embodiment, the pattern of inactivity can be within the viewing area of the electrochromic device. The viewing area can be the area in which the electrochromic device switches from a clear to tinted state prior to patterning. In another embodiment, the pattern of inactivity can have an area that can be between 5% and 50% the viewing area of the electrochromic device.

While employing a telecommunication device in conjunction with the electrochromic stack, the transparent conductive layers 122 and 130 of the stack can reflect frequencies used in 5G communication such as between 450 MHz to 39 GHz. As such, laser ablating the electrochromic stack in certain patterns so as to minimally impact the performance of the electrochromic device can also increase the amount of signals that pass through the electrochromic device.

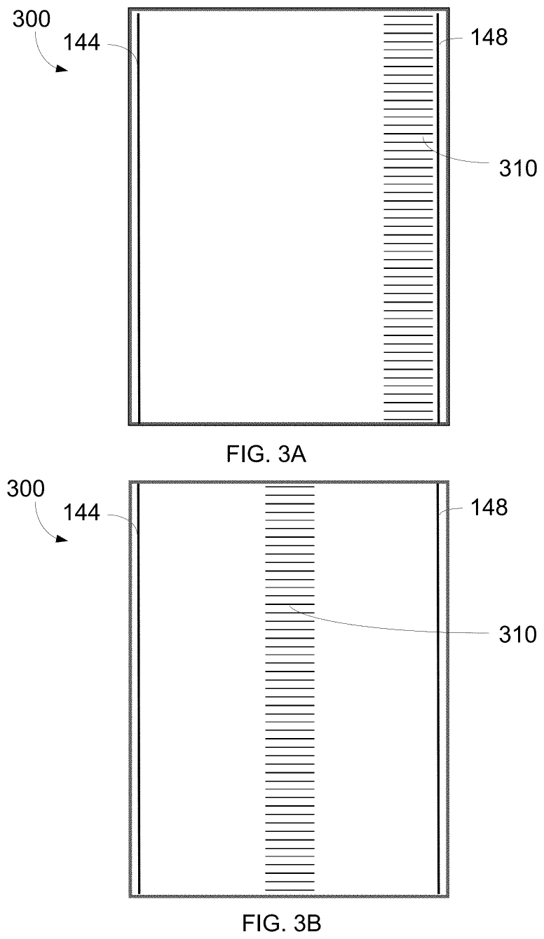

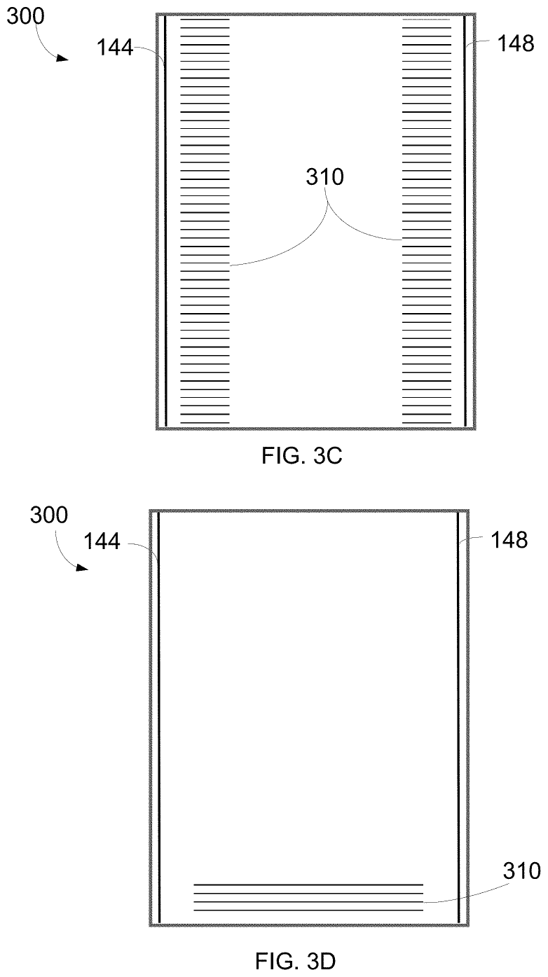

The method can continue, at step 220, by scribing the electrochromic device 100 in the determined pattern of inactivity within a visible area of the electrochromic device. In one embodiment, scribing the electrochromic device 100 can include scribing a plurality of layers between the substrate 110 and the second transparent conductive layer 130. In another embodiment, scribing the electrochromic device 100 can include scribing the second transparent conductive layer 130, the cathodic electrochromic layer 124, the anodic electrochromic layer 128, and the first transparent conductive layer 122. The pattern of inactivity can be the pattern of FIGS. 3A-3D.

FIGS. 3A-3D are schematic top views of one or more electrochromic with a patterned area of inactivity within the electrochromic stack. The one or more electrochromic devices electrochromic devices 300 can be the same as the electrochromic device 100 described above. In one embodiment, as seen in FIG. 3A, the pattern of inactivity 310 can be a striped pattern. In one embodiment, the stripes can be uniform in width. In another embodiment, the stripes can be non-uniform. In another embodiment, the stripes can be in a horizontal orientation. The pattern 310 can be formed by selectively etching the first transparent conductor layer 122, the cathodic electrochemical layer 124, the anodic electrochemical layer 128, and the second transparent conductor layer 130. In one embodiment, the pattern 310 can be formed in both the transparent conductive layer 130 and the transparent conductive layer 122. In one embodiment, the pattern can be non-uniform. The pattern 310 can be orthogonal to the bus bars and extend the length of the bus bars. In one embodiment, the patterned area 310 can allow 5G frequencies to pass through while the non-patterned area reflects those frequencies. In one embodiment, as seen in FIG. 3A, the pattern 310 can be on one side of the electrochromic device. In other words, the pattern 310 can be closer to the bus bar 148 than to bus bar 144. In one embodiment, the pattern 310 can have one or more lines, where each line has a length that extends between ⅙ and 1/10 the length of the electrochromic device. In one embodiment, the one or more lines of the pattern 310 can each have a length that is the same as all other lines within the pattern 310. In one embodiment, the pattern 310 can have one or more lines that are between 0.5 mm and 1 mm in thickness.

In another embodiment, the one or more lines have spaces between each line. In another embodiment, as seen in FIG. 3B, the pattern 310 can be centered or equally spaced between the two bus bars. In another embodiment, as seen in FIG. 3C, the patter 310 can include two columns, each column containing one or more lines. In one embodiment, each column is closer to the edge of the electrochromic than to the center of the electrochromic device. In another embodiment, as seen in FIG. 3D, the pattern 310 can include one or more lines with a length that is between 60% and 80% the length of the side of the electrochromic device. In another embodiment, the pattern can have a height that is between 10% and 90% a length of a first bus bar. In one embodiment, the pattern 310 can be patterned using laser ablation.

In an electrochromic device, the two transparent conductors 122, 130 create a voltage gradient that is generally perpendicular to the bus bars. If a laser pattern that ablated the whole film is perpendicular to voltage gradient, electrons flow may be hindered by these obstacles. As such, the electrochromic device is laser ablated in a pattern that is parallel to the voltage gradient of the electrochromic device. Laser patterns that ablate the whole film generate electron paths that are longer than normal. Thus, the effective resistance of a patterned region tends to increase and leads to slower switching areas. In the worst case, the area that is patterned may not tint at all because the voltage within that area is not sufficient. However, by making the pattern 210 in uniform, horizontal lines, leakage current between the lines can offset the increased path such that the areas that are ablated still look tinted as the electrochromic device switches from a clear state to a tinted state.

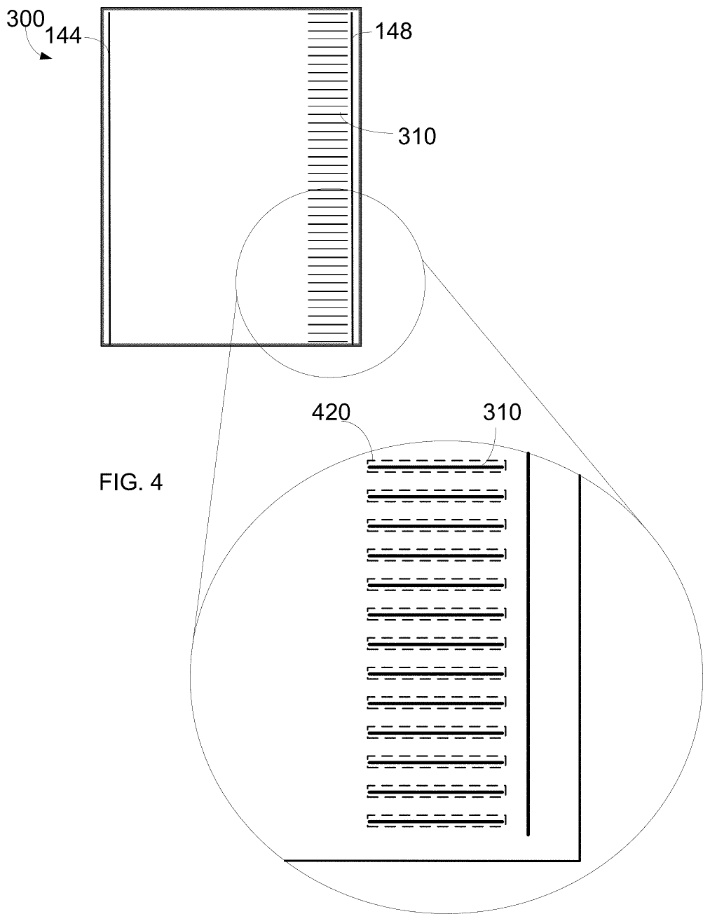

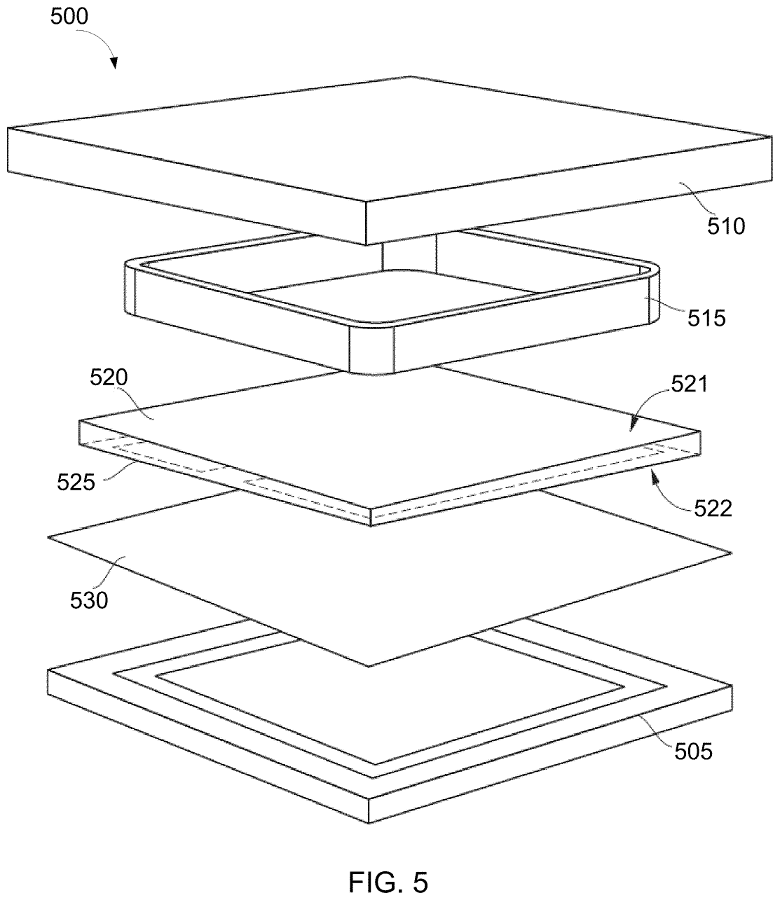

The method can continue at step 230 by determining a cloaking pattern 420. Determining a cloaking pattern can include knowing the areas of inactivity. In one embodiment, the cloaking pattern 420 can be identical to the pattern of inactive areas 310. In another embodiment, the cloaking pattern 420, as seen in FIG. 4, can be 10% larger than the pattern of inactive areas 310. In one embodiment, the cloaking pattern 420 can surround and cover the pattern of inactive area 310.

The method can continue at step 240 by placing a masking layer in the areas of the cloaking pattern. In another embodiment, the masking layer can include an opaque material. In another embodiment the masking layer can include, conjugated polymers, ink, polyester, polyethylene terephthalate, thermoplastic polymer resin, or any combination therein. In another embodiment, the masking layer can be at most 15% larger, such as 10% larger, or 8% larger or 5% larger than the inactive area 310 of the electrochromic device 100. In another embodiment, the masking layer can be at least 0.001% larger, such as 0.01% larger, or 0.1% larger, or 1% larger than the inactive area 310 of the electrochromic device 100. In another embodiment, the masking layer is the exact size of the inactive area 310. In one embodiment, the masking layer is deposited on the substrate. In another embodiment, the masking layer can be deposited on an external glass pane after the electrochromic device has been processed as a glazing unit, as described below. In one embodiment, the masking layer is deposited to fill the ablated areas created within the electrochromic device 100. The masking layer advantageously creates an illusion to a viewer. While the electrochromic device 100 is in the clear state, the masking layer in the cloaking pattern tricks the eye to blend into the clear state. When the electrochromic device 100, is in the tinted state, the masking layer in the cloaking pattern blends into the tinted area of the electrochromic device creating a uniform viewing area for the electrochromic device 100.

Any of the electrochromic devices can be subsequently processed as a part of an insulated glass unit. FIG. 5 is a schematic illustration of an insulated glazing unit 500 according to the embodiment of the current disclosure. The insulated glass unit 500 can include a first panel 505, an electrochemical device 520 coupled to the first panel 505, a second panel 510, and a spacer 515 between the first panel 505 and second panel 510. The first panel 505 can be a glass panel, a sapphire panel, an aluminum oxynitride panel, or a spinel panel. In another embodiment, the first panel can include a transparent polymer, such as a polyacrylic compound, a polyalkene, a polycarbonate, a polyester, a polyether, a polyethylene, a polyimide, a polysulfone, a polysulfide, a polyurethane, a polyvinylacetate, another suitable transparent polymer, or a co-polymer of the foregoing. The first panel 505 may or may not be flexible. In a particular embodiment, the first panel 505 can be float glass or a borosilicate glass and have a thickness in a range of 2 mm to 20 mm thick. The first panel 505 can be a heat-treated, heat-strengthened, or tempered panel. In one embodiment, the electrochemical device 520 is coupled to first panel 505. In another embodiment, the electrochemical device 520 is on a substrate 525 and the substrate 525 is coupled to the first panel 505. In one embodiment, a lamination interlayer 330 may be disposed between the first panel 505 and the electrochemical device 520. In one embodiment, the lamination interlayer 530 may be disposed between the first panel 505 and the substrate 525 containing the electrochemical device 520. The electrochemical device 520 may be on a first side 521 of the substrate 525 and the lamination interlayer 330 may be coupled to a second side 522 of the substrate. The first side 521 may be parallel to and opposite from the second side 522.

The second panel 510 can be a glass panel, a sapphire panel, an aluminum oxynitride panel, or a spinel panel. In another embodiment, the second panel can include a transparent polymer, such as a polyacrylic compound, a polyalkene, a polycarbonate, a polyester, a polyether, a polyethylene, a polyimide, a polysulfone, a polysulfide, a polyurethane, a polyvinylacetate, another suitable transparent polymer, or a co-polymer of the foregoing. The second panel may or may not be flexible. In a particular embodiment, the second panel 510 can be float glass or a borosilicate glass and have a thickness in a range of 5 mm to 30 mm thick. The second panel 510 can be a heat-treated, heat-strengthened, or tempered panel. In one embodiment, the spacer 515 can be between the first panel 505 and the second panel 510. In another embodiment, the spacer 515 is between the substrate 525 and the second panel 510. In yet another embodiment, the spacer 515 is between the electrochemical device 520 and the second panel 510.

In another embodiment, the insulated glass unit 500 can further include additional layers. The insulated glass unit 500 can include the first panel, the electrochemical device 520 coupled to the first panel 505, the second panel 510, the spacer 515 between the first panel 505 and second panel 510, a third panel, and a second spacer between the first panel 305 and the second panel 510. In one embodiment, the electrochemical device may be on a substrate. The substrate may be coupled to the first panel using a lamination interlayer. A first spacer may be between the substrate and the third panel. In one embodiment, the substrate is coupled to the first panel on one side and spaced apart from the third panel on the other side. In other words, the first spacer may be between the electrochemical device and the third panel. A second spacer may be between the third panel and the second panel. In such an embodiment, the third panel is between the first spacer and second spacer. In other words, the third panel is couple to the first spacer on a first side and coupled to the second spacer on a second side opposite the first side.

The embodiments described above and illustrated in the figures are not limited to rectangular shaped devices. Rather, the descriptions and figures are meant only to depict cross-sectional views of a device and are not meant to limit the shape of such a device in any manner. For example, the device may be formed in shapes other than rectangles (e.g., triangles, circles, arcuate structures, etc.). For further example, the device may be shaped three-dimensionally (e.g., convex, concave, etc.).

Many different aspects and embodiments are possible. Some of those aspects and embodiments are described below. After reading this specification, skilled artisans will appreciate that those aspects and embodiments are only illustrative and do not limit the scope of the present invention. Exemplary embodiments may be in accordance with any one or more of the ones as listed below.

Embodiment 1. A method of cloaking an electrochromic device can include scribing the electrochromic device to include a pattern of inactive areas within a visible area of the electrochromic device, determining a cloaking pattern that corresponds to the pattern of inactive areas, and placing a masking layer in the areas of the cloaking pattern.

Embodiment 2. The method of embodiment 1, where the electrochromic device can include a first transparent conductive layer on a substrate, a second transparent conductive layer, a cathodic electrochromic layer between the first transparent conductive layer and the second transparent conductive layer and an anodic electrochromic layer between the first transparent conductive layer and the second transparent conductive layer.

Embodiment 3. The method of embodiment 2, where the pattern of inactive areas is parallel to a voltage gradient of the electrochromic device.

Embodiment 4. The method of embodiment 1, where the cloaking pattern is within the visible area of the electrochromic device.

Embodiment 5. The method of embodiment 1, where the masking layer is opaque.

Embodiment 6. The method of embodiment 1, where the cloaking pattern is between 5% and 50% of the visible area.

Embodiment 7. The method of embodiment 1, where the cloaking pattern is identical to the pattern of inactive areas.

Embodiment 8. The method of embodiment 1, where the cloaking pattern surrounds the pattern of inactive areas.

Embodiment 9. The method of embodiment 8, where the cloaking pattern is 10% larger than the pattern of inactive areas.

Embodiment 10. The method of embodiment 8, where the cloaking pattern in 1% larger than the pattern of inactive areas.

Embodiment 11. The method of embodiment 2, where the masking layer is deposited over the substrate.

Embodiment 12. The method of embodiment 1, where the pattern of inactive areas includes one or more lines.

Embodiment 13. The method of embodiment 12, where the one or more lines are uniform and extend through a first transparent conductive layer, a second transparent conductive layer, a cathodic electrochromic layer between the first transparent conductive layer and the second transparent conductive layer, and an anodic electrochromic layer of the electrochromic device.

Embodiment 14. The method of embodiment 1 further can include a first bus bar and a second bus bar.

Embodiment 15. The method of embodiment 2, where the substrate can include glass, sapphire, aluminum oxynitride, spinel, polyacrylic compound, polyalkene, polycarbonate, polyester, polyether, polyethylene, polyimide, polysulfone, polysulfide, polyurethane, polyvinylacetate, another suitable transparent polymer, co-polymer of the foregoing, float glass, borosilicate glass, or any combination thereof.

Embodiment 16. The method of embodiment 2, where each of the one or more electrochromic devices further can include an ion conducting layer between the cathodic electrochemical layer and the anodic electrochemical layer.

Embodiment 17. The method of embodiment 16, where the ion-conducting layer can include lithium, sodium, hydrogen, deuterium, potassium, calcium, barium, strontium, magnesium, oxidized lithium, Li₂WO₄, tungsten, nickel, lithium carbonate, lithium hydroxide, lithium peroxide, or any combination thereof.

Embodiment 18. The method of embodiment 2, where the electrochromic layer can include WO₃, V₂O₅, MoO₃, Nb₂O₅, TiO₂, CuO, Ni₂O₃, NiO, Ir₂O₃, Cr₂O₃, CO₂O₃, Mn₂O₃, mixed oxides (e.g., W—Mo oxide, W—V oxide), lithium, aluminum, zirconium, phosphorus, nitrogen, fluorine, chlorine, bromine, iodine, astatine, boron, a borate with or without lithium, a tantalum oxide with or without lithium, a lanthanide-based material with or without lithium, another lithium-based ceramic material, or any combination thereof.

Embodiment 19. The method of embodiment 2, where the first transparent conductive layer can include indium oxide, indium tin oxide, doped indium oxide, tin oxide, doped tin oxide, zinc oxide, doped zinc oxide, ruthenium oxide, doped ruthenium oxide, silver, gold, copper, aluminum, and any combination thereof.

Embodiment 20. The method of embodiment 2, where the second transparent conductive layer can include indium oxide, indium tin oxide, doped indium oxide, tin oxide, doped tin oxide, zinc oxide, doped zinc oxide, ruthenium oxide, doped ruthenium oxide and any combination thereof.

Embodiment 21. The method of embodiment 2, where the anodic electrochemical layer can include a an inorganic metal oxide electrochemically active material, such as WO₃, V₂O₅, MoO₃, Nb₂O₅, TiO₂, CuO, Ir₂O₃, Cr₂O₃, Co₂O₃, Mn₂O₃, Ta₂O₅, ZrO₂, HfO₂, Sb₂O₃,a lanthanide-based material with or without lithium, another lithium-based ceramic material, a nickel oxide (NiO, Ni₂O₃, or combination of the two), and Li, nitrogen, Na, H, or another ion, any halogen, or any combination thereof.

Embodiment 22. A method of cloaking an electrochromic device can include determining a pattern of inactive areas within a visible area of the electrochromic device, determining a cloaking pattern that corresponds to the pattern of inactive areas, and depositing a masking layer in the areas of the cloaking pattern, where the cloaking pattern is parallel to a voltage gradient of the electrochromic device.

Embodiment 23. An electrochromic device can include a stack of layers which can include a first transparent conductive layer on a substrate, a second transparent conductive layer, a cathodic electrochromic layer between the first transparent conductive layer and the second transparent conductive layer, and an anodic electrochromic layer between the first transparent conductive layer and the second transparent conductive layer. The electrochromic device can also include a patterned inactive area, where the patterned inactive area is an area through each of the first transparent conductive layer, the second transparent conductive layer, the cathodic electrochromic layer, and the anodic electrochromic layer and a making layer that covers the patterned inactive area.

Embodiment 24. The electrochromic device of embodiment 23, where patterned inactive area can include one or more lines in parallel.

Embodiment 25. The electrochromic device of embodiment 24, where each of the one or more parallel lines have a length that is between 60% and 80% a length of a side of the electrochromic device.

Embodiment 26. The electrochromic device of embodiment 24, where each of the one or more parallel lines have a length that is between 5% and 20% a length of a side of the electrochromic device.

Embodiment 27. The electrochromic device of embodiment 23, where the patterned inactive area has a height that is between 10% and 90% a length of a first bus bar.

Embodiment 28. The electrochromic device of embodiment 23, where the patterned inactive area is non-uniform.

Embodiment 29. The electrochromic device of embodiment 24, where the patterned inactive area allows 5G frequencies range from 450 MHz to 39 GHz to pass through the electrochromic device.

Note that not all of the activities described above in the general description, or the examples are required, that a portion of a specific activity may not be required, and that one or more further activities may be performed in addition to those described. Still further, the order in which activities are listed is not necessarily the order in which they are performed.

Certain features that are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A method of cloaking an electrochromic device, comprising:
scribing the electrochromic device to include a pattern of inactive areas within a visible area of the electrochromic device;
determining a cloaking pattern that corresponds to the pattern of inactive areas; and
placing a masking layer in the areas of the cloaking pattern.

2. The method of claim 1, wherein the electrochromic device comprises:
a first transparent conductive layer on a substrate;
a second transparent conductive layer;
a cathodic electrochromic layer between the first transparent conductive layer and the second transparent conductive layer; and
an anodic electrochromic layer between the first transparent conductive layer and the second transparent conductive layer.

3. The method of claim 2, wherein the pattern of inactive areas is parallel to a voltage gradient of the electrochromic device.

4. The method of claim 1, wherein the cloaking pattern is within the visible area of the electrochromic device.

5. The method of claim 1, wherein the masking layer is opaque.

6. The method of claim 1, wherein the cloaking pattern is between 5% and 50% of the visible area.

7. The method of claim 1, wherein the cloaking pattern is identical to the pattern of inactive areas.

8. The method of claim 1, wherein the cloaking pattern surrounds the pattern of inactive areas.

9. The method of claim 8, wherein the cloaking pattern is 10% larger than the pattern of inactive areas.

10. The method of claim 8, wherein the cloaking pattern in 1% larger than the pattern of inactive areas.

11. The method of claim 2, wherein the masking layer is deposited over the substrate.

12. The method of claim 1, wherein the pattern of inactive areas comprises one or more lines.

13. The method of claim 12, wherein the one or more lines are uniform and extend through a first transparent conductive layer, a second transparent conductive layer, a cathodic electrochromic layer between the first transparent conductive layer and the second transparent conductive layer, and an anodic electrochromic layer of the electrochromic device.

14. The method of claim 1, further comprising a first bus bar and a second bus bar.

15. A method of cloaking an electrochromic device, comprising:
determining a pattern of inactive areas within a visible area of the electrochromic device;
determining a cloaking pattern that corresponds to the pattern of inactive areas; and
depositing a masking layer in the areas of the cloaking pattern, wherein the cloaking pattern is parallel to a voltage gradient of the electrochromic device.

16. An electrochromic device, comprising:
a stack of layers comprising:
a first transparent conductive layer on a substrate;
a second transparent conductive layer;
a cathodic electrochromic layer between the first transparent conductive layer and the second transparent conductive layer; and
an anodic electrochromic layer between the first transparent conductive layer and the second transparent conductive layer;
a patterned inactive area, wherein the patterned inactive area is an area through each of the first transparent conductive layer, the second transparent conductive layer, the cathodic electrochromic layer, and the anodic electrochromic layer; and
a making layer that covers the patterned inactive area.

17. The electrochromic device of claim 16, wherein patterned inactive area comprises one or more lines in parallel.

18. The electrochromic device of claim 16, wherein each of the one or more parallel lines have a length that is between 60% and 80% a length of a side of the electrochromic device.

19. The electrochromic device of claim 16, wherein the patterned inactive area is non-uniform.

20. The electrochromic device of claim 16, wherein the patterned inactive area allows 5G frequencies range from 450 MHz to 39 GHz to pass through the electrochromic device.
